(19) United States
(12) Patent Application Publication
(10) Pub. No.: US 2014/0032176 A1
(43) Pub. Date: Jan. 30, 2014

(54) VIDEO OR AUDIO PROCESSING FORMING AN ESTIMATED QUANTILE

(71) Applicant: Snell Limited, Berkshire (GB)

(72) Inventor: Michael James Knee, Petersfield (GB)

(21) Appl. No.: 13/950,469

(22) Filed: Jul. 25, 2013

(30) Foreign Application Priority Data
Jul. 26, 2012 (GB) 1213358.3

(51) Int. Cl. G06F 17/00

(52) U.S. Cl. CPC G06F 17/00
USPC 702/189

(57) ABSTRACT

A method of video or audio processing receives a sequence of sample values, each corresponding with a location in video or audio content; forms an initially estimated quantile value; and then modifies the estimated value in dependence upon a count of the results of comparisons between sample values within a fixed-length interval of the sequence of samples values and the estimated value to form an estimated quantile of the sequence of sample values.

### FIELD OF INVENTION

This invention concerns video or audio processing.

### BACKGROUND OF THE INVENTION

A known problem in video or audio processing concerns the selection of a subset of samples from an image to represent that image. A subset of samples representing an image can be used—for example—to track or monitor spatial processing of the image; to simplify matching of images to measure time shifts or delays; or to provide signatures. It is useful to select samples with reference to the sample values (rather than from just their locations in the image or indeed rather than randomly) so that a distinctive representation is formed by the subset. In one case samples may be selected from areas of the image showing high levels of activity or large differences between a sample value and the values of neighbouring samples. If it were desired, for example, to form a representation of an image containing one million samples by selecting those 10,000 samples having the highest activity level, it would be possible to measure the activity level of all samples; store those activity levels with of course the corresponding locations in the image of those samples; measure in a known manner the upper percentile of the activity level; and then select for the representation those 10,000 samples having activity levels at or above the upper percentile threshold.

The upper percentile is or course a well understood statistical measure. More generally, if data is numerical or, more generally, is taken from an ordered set of possibilities, then a useful measurement that can be taken is a quantile, of which the median is the simplest example. The median is a form of average and is the data point that is halfway along an ordered set of data, or, in terms of frequency distribution, the point at which the cumulative frequency equals 0.5. Other examples of quantiles in frequent use include the lower and upper quartiles (at which the cumulative frequency equals 0.25 and 0.75 respectively), the lower and upper deciles (0.1 and 0.9) and the 1^{st} and 99^{th} centiles or percentiles (0.01 and 0.99). In this Specification, the term quantile fraction is used to refer to a specified fractional point in the distribution (for example 0.25, 0,75, 0.1, 0.9 etc.). The remainder after subtracting the quantile fraction from unity will be termed the complement of the quantile fraction. And the term quantile is used to refer to the quantity being estimated from the data.

The need for reliable estimation of a given quantile of a distribution has long been recognized. Known methods include explicit sorting of the data and counting an appropriate number of samples in the sorted set, and forming a histogram of the data as an estimate of the frequency distribution. For large data sets, both these methods require a substantial quantity of processing or of memory. Recently, attention has been given to quantile estimation using limited memory, for example in Manku et al, “Approximate Medians and other Quantiles in One Pass and with Limited Memory”, in SIGMOD, pages 426-435, 1998. In another paper on quantile estimation, Takeuchi et al, in “Nonparametric Quantile Estimation”, Journal of Machine Learning Research 7 (2006) pp 1231-1264, introduce the “pinball loss function” in which errors in a quantile estimate are asymmetrically weighted according to the quantile fraction.

The requirement for quantile estimation in sequential data, with either stationary or non-stationary statistics, is recognized in U.S. patent 20090138238, Bakshi and Hoeflin, which teaches a method based on sequential updating of a quantile estimate and of a standard deviation estimate.

The inventor has recognized that prior art quantile estimation methods may be reasonably accurate but require fairly complex processing. They are not suited to the above application of selecting a given number of audio or video samples where large numbers of images or frames require processing with limited time and processing power. The prior art methods are similarly not suited to a range of other video or audio applications where, the accuracy required of the quantile determination may not be particularly high, but the availability of time, memory and processing capacity may be severely restricted. It is an object of one aspect of this invention to provide a method of video or audio processing utilising quantile estimation in a simple manner with minimal memory requirements, but which is also appropriately responsive to changes in statistics.

It is an object of a further aspect of this invention to provide apparatus for quantile estimation that is extremely simple and has minimal memory requirements, but which is also responsive to changes in data statistics.

### SUMMARY OF THE INVENTION

In one aspect, the present invention consist in a method of video or audio processing comprising the steps in one or more processors of: receiving a sequence of sample values, each sample value corresponding with a location in video or audio content; forming an initially estimated quantile value; modifying the initially estimated quantile value in dependence upon a count of the results of comparisons between sample values within a fixed-length interval of the said sequence of samples values and the said initially estimated quantile value to form an estimated quantile of the sequence of sample values.

The estimated quantile may be used, for example, as a threshold for sample values to select samples or locations representative of the video or audio content. In another example, the estimated quantile value may be output as a representative of the sample values.

Preferably, the modification is proportional to the difference between:

the product of the quantile fraction and the number of samples that exceed the estimate; and

the product of the complement of the quantile fraction and the number of samples that are less than the estimate.

In one form of the invention, a plurality of fixed-length intervals are analysed and a sequence of quantile estimates is output comprising, for each input sample value, the respective sum of the modified quantile estimate from a preceding interval and the instantaneous value of the modification for that sample.

In another aspect, the present invention consist in apparatus for estimating a quantile fraction of a sequence of data values, comprising an estimated quantile value store, configured to receive an initially estimated quantile value; a comparator configured to form comparisons between data values within a fixed-length interval of the said sequence of data values and the estimated quantile value of the store and a modifier configured to modify the estimated quantile value of the store in dependence upon a count of the results of said comparisons.

### BRIEF DESCRIPTION OF THE DRAWINGS

Examples of the invention will now be described with reference to the drawings in which:

FIG. 1 is a block diagram of a first embodiment of the invention;

FIG. 2 is a block diagram of a first embodiment of a quantile estimator for use in FIG. 1 or separately;

FIG. 3 is a block diagram of a second embodiment of a quantile estimator;

FIG. 4 is a block diagram of a third embodiment of a quantile estimator;

FIG. 5 is a set of graphs illustrating the performance of the invention.

### DETAILED DESCRIPTION OF THE INVENTION

A first embodiment of the invention concerns the selection of a subset of samples from each of a succession of frames in a video sequence, according to a measure of activity or interest. There is typically a requirement for a predetermined number of samples in the subset, although minor variations in the number of samples selected per frame will usually be of no operational significance.

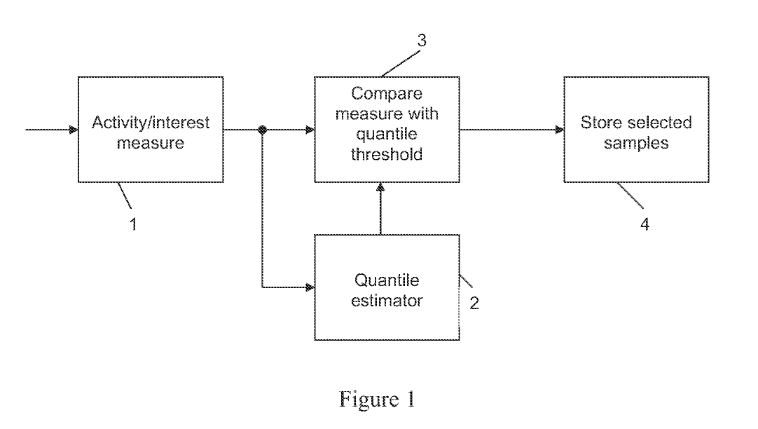

As shown in FIG. 1, samples—which may be RGB or other values of each pixel in a frame—are provided to an activity/interest measure (1). This may take a wide variety of forms and the detail is not germane to the present invention. The sample measures are provided sequentially to a quantile estimation unit (2) which in turn provides an estimated quantile value to a comparator (3). This comparator serves to select those samples which pass the threshold of the estimated quantile value and the selected samples are stored in store (4). Unselected samples are simply rejected.

The quantile fraction of the quantile estimator is set to produce the desired number (or approximately the desired number) of samples in the selected subset. As an estimate of the quantile is made available without waiting for the processing of all samples in the frame, the subset of selected samples is available faster. Moreover the minimum size of the store (4) is determined by the desired number of samples in the subset and not by the number of pixels in the frame.

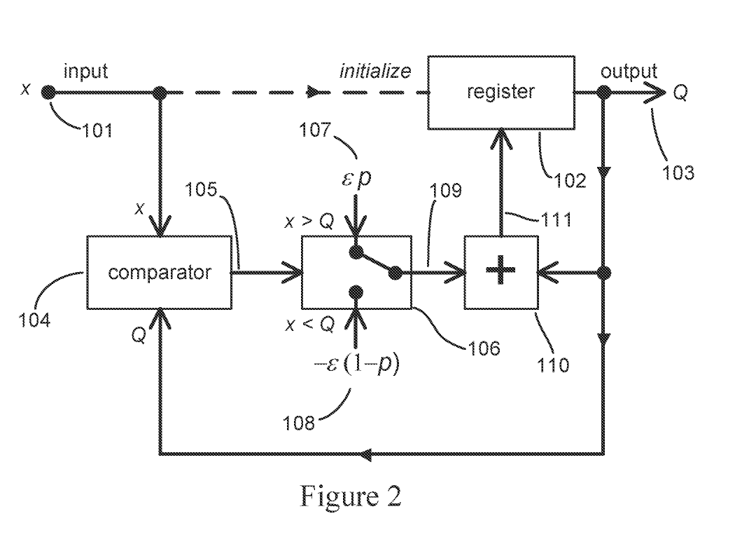

A first embodiment of the quantile estimator (2) will now be described with reference to FIG. 2, which show a sequential process that receives a sequence of data samples, and outputs a sequence of estimates of a particular quantile of the input data, at a rate of one output estimate per input data sample.

Input data samples x arrive sequentially at the input (101). At the start of the process a register (102) is initialized by loading it with the value of the first input data sample. As the process continues, the register (102) stores a current estimate of the required quantile and passes it to the output Q (103). The register (102) operates at the input data rate and has a delay of one input sample period, that is to say its current output is equal to a valued loaded into it that depends on the previous input data sample.

Each input data sample x (101) is compared with the output Q (103) in a comparator (104). The result (105) of the comparison is used in a data selector (106) to select between two fixed numbers: εp (107) if x>Q; or, −ε(1−p) (108) if x<Q. The selected fixed number (109) is input to an adder (110). The value of p is a constant equal to the desired quantile fraction. Thus when the current input data sample x is greater than the estimate Q, the product of the required quantile fraction p and the constant ε is passed to the adder (110); and, when the current input data sample x is less than the estimate Q, the product of the complement of the required quantile fraction p and the constant ε is passed to the adder (110).

ε is a small constant whose value is chosen as a trade-off between smoothness of the output and responsiveness to initial conditions and to changes in the input signal statistics. If the result of the comparison is equality, then zero, or either of the two fixed inputs, may be selected. The output (109) of the data selector is added (110) to the current output Q (103) of the register (102) to form an updated quantile estimate (111), which is loaded into the register (102), and will be output when the next input data sample x (101) arrives.

The reasoning behind the algorithm is as follows: If Q=q, where q is the true value of the desired quantile, then its expected increase will be (1−p)εp and the expected decrease will be pε(1−p), so Q will have no tendency to change in the long term. However, if Q<q, then the expected increase will be greater than (1−p)εp (because it will be applied more often than a proportion (1−p) of the time) and the expected decrease will be less than pε(1−p), so Q will tend to increase towards q. Likewise, if Q>q, then Q will tend to decrease towards q.

Variations to the first embodiment may be applied by the skilled person without departing from the scope of the invention. For example, the initial estimate of the quantile may be set to zero, or to a constant value derived from prior knowledge of the data. The sequence of output quantile estimates Q may also be filtered by a smoothing filter.

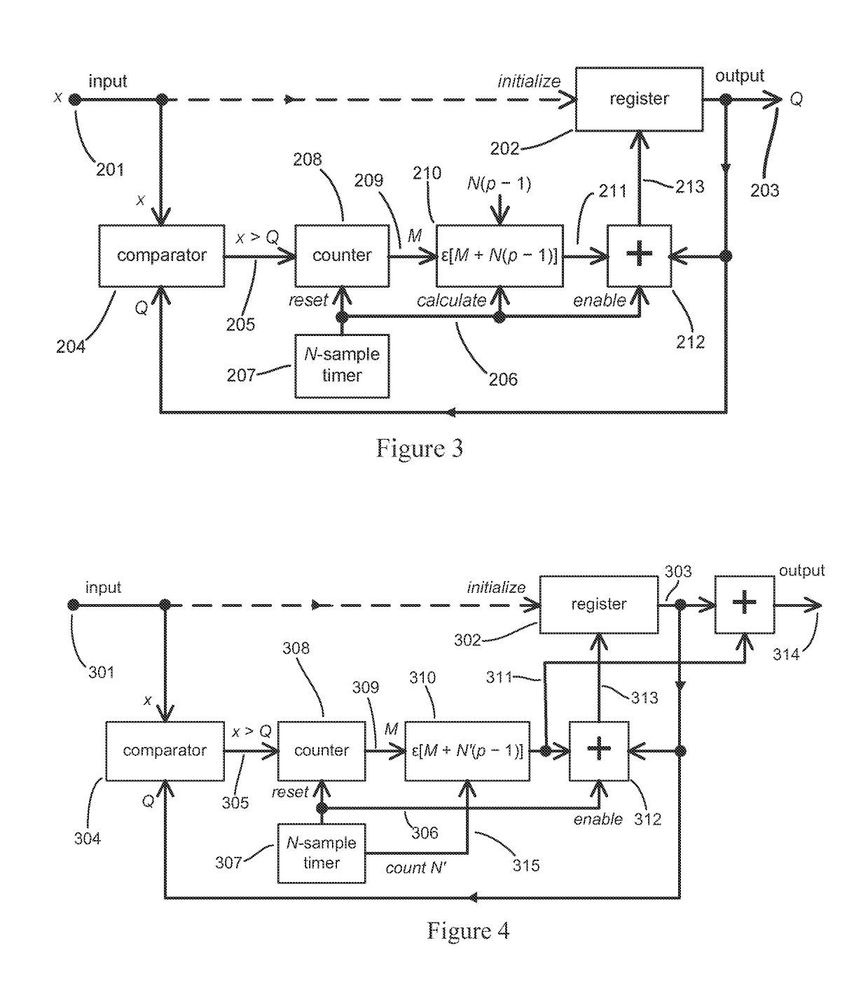

A second embodiment of the invention will now be described, and is illustrated in FIG. 3 in which elements analogous with elements of FIG. 2 have similar designatory numerals with the initial digit 1 replaced by 2. The second embodiment has two advantages over the first embodiment. The first advantage is that it avoids the single-sample-period loop during which the first embodiment must: read from the register; perform a comparison; select between two numbers according to the comparison; perform an addition; and, write the result back into the register. The second advantage is that it improves the tradeoff between smoothness and response time. The second embodiment makes comparisons on every incoming data sample, but only changes the estimate Q at fixed intervals a chosen, set number, of input data samples apart. Supposing for the moment that equality does not occur in the comparisons, the process only needs to keep account of the number of times the input sample x exceeds the held value of Q in the register (202) in order to calculate the change to be made to Q at the end of the interval. For example, if the chosen interval is N data points, and the number of times x exceeds Q is M, then the net increase to be applied to Q at the end of the interval is ε[Mp−(N−M)(1−p)]=ε[M+N(p−1)].

Referring to FIG. 3, the first input data sample x (201) initializes the register (202) that operates in a similar way to the register (102) of the first embodiment, except that it is only loaded with a new quantile estimate every N input samples. Subsequent input data samples pass to a first input to a comparator (204), whose other input is the output Q (203) from the register (202), as in the first embodiment. The output (205) of the comparator (204) drives a counter (208) which increments every time x>Q. The counter is regularly reset to zero by the output (206) of an N-sample timer (207). The regular output from the N-sample timer (207) also enables the calculation (210) of a new value of the quantity ε[M+N(p−1)], where M is the state (209) of the counter (208). The result (211) of the calculation is added (212) to the currently output quantile estimate (203) to produce a new quantile estimate (213), which is written into the register (202), and will be output when the register (202) is next loaded after N input data samples have been received.

Several possible methods exist for handling equality in the comparisons. Firstly, the relative quantization of the input data and of the quantile estimate could be arranged so that equality cannot occur, or occurs very rarely. Secondly, equality could be treated arbitrarily, or, randomly as one of the two other outcomes. Thirdly, two counters could be employed, so that all three outcomes from the comparator could properly be recorded.

A third embodiment of the invention will now be described, and is illustrated in FIG. 4 in which elements analogous to those of FIG. 3 have similar designatory numerals with the initial digit 2 replaced by 3. This embodiment is similar to the second embodiment, except that an out-of-loop correction is added to the final output to improve the response time at the expense of a slight increase in complexity. Referring to FIG. 4, the operation is similar to that shown in FIG. 3 except for the following differences: The calculation unit (310) operates every time an input data sample is received, using the instantaneous count value M (309) and an additional sample-count output N′ (315) from the N-sample timer. The register (302) is loaded with a new quantile estimate (313) at the end of each N-sample segment of the input data stream, in exactly the same way as in the second embodiment. However, the calculated output (311) corresponding to every input data sample is added to the output (303) of the register (302) to produce a final output quantile estimate (314) every time an input data sample is received.

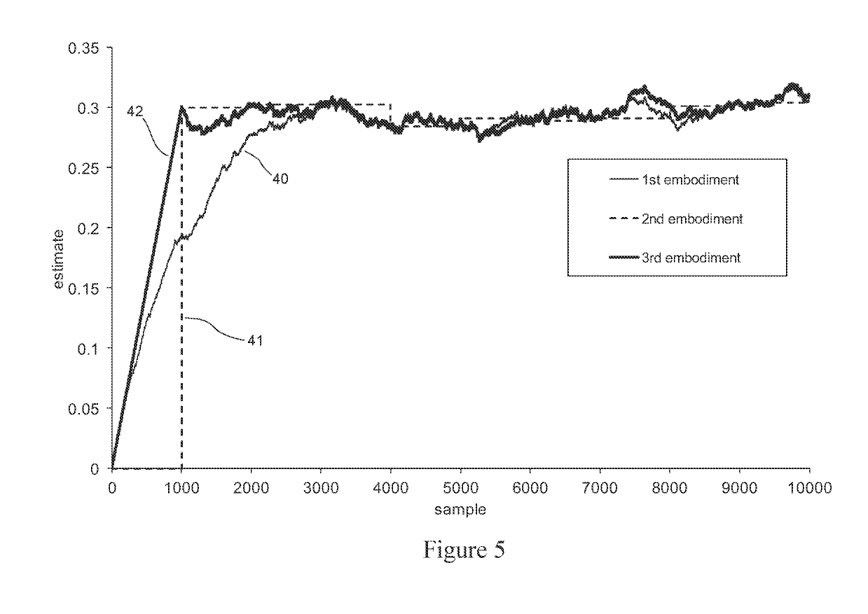

FIG. 5 gives a comparative illustration of the performance of the three embodiments described. In this example, the 30^{th} centile (p=0.3) of the distribution of data uniformly distributed on [0, 1] is being estimated, for which the expected value q is 0.3. The value of ε is 1/1000.

The output of the first embodiment, in which Q is updated in the loop at every sample, is shown as a fine line (40). This version takes about 3000 sample periods to converge to an approximately correct value. The output of the second embodiment, in which the estimate is only updated (in this case) every N=1000 samples, is shown as a dotted line (41). It converges to a correct value in 1000 samples. Finally, the output of the third embodiment, in which a sample-rate out-of-loop correction is added at the end, is shown as a thick line (42). This is similar to the first embodiment except that it converges more quickly.

Three exemplary embodiments of the invention have been described in terms of sequential processes operating in inter-connected functional blocks. However, the skilled person will recognise that the described inventive concept can be practiced in many other ways. For example the data sequence may not be a temporal sequence, it may be a spatial sequence, or some other sequence in which a plurality of data values are arranged in an ordered set. The concept of an interval within the set of input values may not be a period of time; an interval is a contiguous set of samples in the ordered set of input samples, and its length is the number of samples that it comprises.

The data samples to be processed may be simultaneously accessible in a file or memory device. The invention may be implemented in a sequence of instructions for a programmable device.

The described quantile estimators may be used in other ways in video or audio processing. For example, it is common to monitor a quality or other parameter of video or audio content at block, frame or other intervals. One such parameter is a blockiness measure of compression decoded video. The monitoring may be conducted in real or close to real time, so that remedial action can be taken promptly. Since instantaneous variations may be insignificant (or of less significance) in quality terms, a running average may be preferred, although this of course must introduce minimal delay to preserve close to real time processing.

In many applications, a running average may not represent an appropriate statistical measure. Quality levels may be set by regulation or by commercial agreement and it is often preferable to set such quality levels by reference to quantiles. It will thus be seen that the present invention affords the advantage of providing an estimate of the statistical measure that is of commercial importance in a time frame that still permits remedial action to be taken.

Whilst mention has been made of pixels and frames, it will be understood that the same techniques can be employed with samples in audio frames. Similarly, the values may be taken from blocks or other frame regions and may be representative of locations in video or audio content specified other than in frames.

1. A method of video or audio processing comprising the steps in one or more processors of:
receiving a sequence of sample values, each sample value corresponding with a location in video or audio content;
forming an initially estimated quantile value;
modifying the initially estimated quantile value in dependence upon a count of the results of comparisons between sample values within a fixed-length interval of the said sequence of samples values and the said initially estimated quantile value to form an estimated quantile of the sequence of sample values.

2. A method according to claim 1, further comprising the step of using the estimated quantile as a threshold for sample values to select samples or locations representative of the video or audio content.

3. A method according to claim 1, further comprising the step of outputting the estimated quantile value as a representative of the sample values.

4. A method according to claim 1 in which the modification is proportional to the difference between:
the product of the quantile fraction and the number of samples that exceed the estimate; and
the product of the complement of the quantile fraction and the number of samples that are less than the estimate.

5. A method according to claim 1 in which the fixed-length interval is one data value in length.

6. A method according to claim 1 in which, a plurality of fixed-length intervals are analysed and the respective modified estimate for each processed interval is output as a quantile estimate.

7. A method according to claim 1 in which a plurality of fixed-length intervals are analysed and a sequence of quantile estimates is output comprising, for each input sample value, the respective sum of the modified quantile estimate from a preceding interval and the instantaneous value of the modification for that sample.

8. Apparatus for estimating a quantile fraction of a sequence of data values, comprising:
an estimated quantile value store, configured to receive an initially estimated quantile value;
a comparator configured to form comparisons between data values within a fixed-length interval of the said sequence of data values and the estimated quantile value of the store; and
a modifier configured to modify the estimated quantile value of the store in dependence upon a count of the results of said comparisons.

9. Apparatus according to claim 8 in which the modification is proportional to the difference between:
the product of the quantile fraction and the number of data samples that exceed the estimate; and,
the product of the complement of the quantile fraction and the number of data samples that are less than the estimate.

10. Apparatus according to claim 8 in which the fixed-length interval is one data value in length.

11. Apparatus according to claim 8 in which, a plurality of fixed-length intervals are analysed and the respective modified estimate for each processed interval is output as a quantile estimate.

12. Apparatus according to claim 8 in which a plurality of fixed-length intervals are analysed and a sequence of quantile estimates is output comprising, for each input data value, the respective sum of the modified quantile estimate from a preceding interval and the instantaneous value of the modification for that data sample.

13. A non-transitory computer program product adapted to cause programmable apparatus to implement a method of video or audio processing comprising the steps of:
receiving a sequence of sample values, each sample value corresponding with a location in video or audio content;
forming an initially estimated quantile value;
modifying the initially estimated quantile value in dependence upon a count of the results of comparisons between sample values within a fixed-length interval of the said sequence of samples values and the said initially estimated quantile value to form an estimated quantile of the sequence of sample values.

14. A non-transitory computer program product according to claim 13, further comprising the step of using the estimated quantile as a threshold for sample values to select samples or locations representative of the video or audio content.

15. A non-transitory computer program product according to claim 13, further comprising the step of outputting the estimated quantile value as a representative of the sample values.

16. A non-transitory computer program product according to claim 13 in which the modification is proportional to the difference between:
the product of the quantile fraction and the number of samples that exceed the estimate; and
the product of the complement of the quantile fraction and the number of samples that are less than the estimate.

17. A non-transitory computer program product according to claim 13 in which the fixed-length interval is one data value in length.

18. A non-transitory computer program product according to claim 13 in which, a plurality of fixed-length intervals are analysed and the respective modified estimate for each processed interval is output as a quantile estimate.

19. A non-transitory computer program product according to claim 13 in which a plurality of fixed-length intervals are analysed and a sequence of quantile estimates is output comprising, for each input sample value, the respective sum of the modified quantile estimate from a preceding interval and the instantaneous value of the modification for that sample.
